(19) United States
(12) Patent Application Publication
(10) Pub. No.: US 2022/0180410 A1
(43) Pub. Date: Jun. 9, 2022

(54) computer-implemented user-configurable web-based bidding and review method

(71) Applicant: Bidgig LLC, Columbus, OH (US)

(72) Inventor: Gail Harper-Perry, Columbus, OH (US)

(21) Appl. No.: 17/545,598

(22) Filed: Dec. 8, 2021

Related U.S. Application Data
(60) Provisional application No. 63/122,983, filed on Dec. 9, 2020.

(51) Int. Cl. G06Q 30/02; G06Q 10/06; G06Q 30/00

(52) U.S. Cl. CPC G06Q 30/0282; G06Q 30/018; G06Q 10/06393

(57) ABSTRACT

A web-based system and process for soliciting, obtaining, evaluating, and awarding project or sales bids is disclosed. The system tracks potential project or sales agreement opportunities for subscribers based on industry codes, past bids, or business related interests of potential bidders. The system allows municipalities, businesses, organizations, and other entities to create requests for proposals, and entities interested in applying for project or sales opportunities may do so by uploading, accessing or submitting bidding information to the system. A registered user of the system is able to download information added to the system, or upload new information to the system. The system automatically evaluates each bidder based on objective criteria and assigns each bidder a numeric score viewable by the entity requesting project assistance. Once the entity requesting project assistance selects a winning bid, the winning bidder receives an alert from the system.

### CROSS-REFERENCE TO RELATED APPLICATIONS

This application claims priority to U.S. provisional application 63/122,983 filed Dec. 9, 2020.

### TECHNICAL FIELD

Embodiments of the present disclosure relate generally to a configurable web-based system for soliciting, receiving, evaluating, and awarding project or sales bids.

### BACKGROUND OF THE INVENTION

Municipalities, businesses, agencies, organizations, and other entities or natural persons (collectively “buyer(s)”) have long used the assistance of one or more persons or entities operating independent of the direct, day-to-day control of the buyer (collectively “subcontractor(s),” “suppliers,” or “accepted bidder(s)”) on projects for the benefit of the buyer, or a stakeholder, beneficiary or other related entity thereof. Generally, the subcontractor or supplier receives financial compensation or some other award (collectively “consideration”) from the buyer in exchange for providing a product and/or service. An example of said assistance would be an architect (example subcontractor) rendering architectural drafts of home designs for the benefit of a housing developer (example buyer). Another example of said assistance would be a web developer rendering we-building services to a municipality that is seeking a new website. Yet another example of said assistance would be a concrete company (example supplier) supplying concrete to a municipality for the construction of a new pedestrian pathway. Buyers have long used a bidding processes to evaluate and compare multiple potential subcontractors or potential suppliers (“applicant(s)” or “bidder(s)”). The bidding process may involve the buyer determining the qualifications of each applicant, and making a decision on which applicant(s) shall be awarded the opportunity to receive consideration as a subcontractor or supplier based on the applicant's qualifications and/or the cost of the subcontractor or supplier performing project assistance to the buyer.

Prior bidding methods or processes often involve research and planning on the part of a buyer (“buyer due diligence”) to track potentially qualified bidders who potentially perform project assistance or supply necessary materials to the buyer at a cost affordable to the buyer, and the buyer notifies those potential bidders that the buyer is in need of a supplier or subcontractor (“request for proposal” or “RFP”). In addition, prior bidding methods or processes generally involve research and planning on the part of a bidder (“bidder due diligence”) to find RFPs that align with the bidder's qualifications and general business practices. Following the due diligence and RFP steps, each applicant generally creates and sends to the buyer a tentative report, plan, document, or other communication (collectively the “proposal” or “qualification report”) to demonstrate to the buyer that the applicant has the ability to fulfill the buyer's project requirements set out in the RFP. Thereafter, the buyer reviews each proposal and makes a decision based on bidder qualifications, work proposed, and/or costs to the buyer. Once the buyer decides to accept a particular proposal, the buyer will reach out to that bidder to notify the bidder that its bid has been accepted (the “winning bid” and “winning bidder”).

Conventional bidding methods and processes present several issues to both buyers and applicants. For one, buyer due diligence and bidder due diligence may be time consuming and potentially expensive. A buyer must closely review each bidder's proposal to consider how closely the proposal aligns with the factors that a buyer considers to be the most important to awarding a winning bid. Each proposal may set forth responses in a different way, and/or in a different format, making it time consuming and otherwise burdensome for a bidder to glean the relevant information in order to make a comparison based on factors of highest importance. Even narrowing down a plurality of proposals into a select few for further and serious consideration may take significant time. If multiple people review submitted proposals there may be significant differences in how each of them evaluates certain criteria, resulting in inconsistent evaluations across a pool of proposals. In addition, with conventional bidding methods or processes, an applicant has to create a new qualification report for each new RFP without having a template incorporating electronically stored information (“ESI”) for said qualification report, such as a template including one or more questions from the buyer and answers thereof from the applicant. Furthermore, when a decision is made, the buyer typically reaches out directly to the accepted bidder to inform them that their bid has been accepted. The other bidders would only be notified that their bid was not accepted if the buyer takes the time to intentionally reach out to each bidder separately to inform them of such. Thus, with conventional methods or processes, there are often issues with bidders not knowing that their bid has not been accepted and they are otherwise no longer in a position to potentially be a winning bidder.

### SUMMARY OF THE INVENTION

The present invention provides a user-configurable web-based system and method for facilitating project bidding. According to one exemplary embodiment of the inventive concept, a web-based bid review process comprises a web-based application (“app”) in communication with one or more host data servers, one or more user data servers, and an internet network, where municipalities, businesses, organizations, and other entities or natural persons may create RFPs using various interfaces of the app. Users can configure the system as desired to place certain weight on factors that matter most. RFPs can be created by a user with a variety of questions for each bidder, where the answers to each question are weighted according to the values and priorities of the user.

The app tracks potential project opportunities for applicants based on industry codes set by the applicant, past bids offered by the applicant, or project related interests set by the applicant. In addition, the app tracks potential subcontractors or suppliers for buyers based on industry codes set by the buyer, past bids offered to the buyer, or project related interests set by the buyer. These tracking processes reduce or eliminate the time and resources needed to conduct buyer due diligence. Entities interested in applying for project opportunities may do so by uploading, accessing or submitting bidding information to the app. The present bidding process for potential subcontractors or suppliers is completed simply by the applicant's registering to the app and responding to RFP questions, thus the applicant saves time and money with respect to prior art bidding methods. In addition, information submitted by buyers or applicants is saved to the one or more host data servers so that it may be used in subsequent RFPs or bids.

After a potential subcontractor or supplier submits a bid, the buyer receives an alert or notification that a bid has been submitted. The buyer has the option of downloading all information submitted by the applicant, and the applicant has the option of downloading all information present in the RFP. Applicants are evaluated automatically by the app according to the weighted criteria set by the buyer. The app provides an overall numeric score to each applicant based on objective criteria assigned by the buyer to questions answered by the applicants. The app will determine which applicant has the highest score, and the buyer has the option of finalizing a deal with a preferred applicant. The applicant will receive an alert or notification if the buyer accepts that applicant's bid. Once a winning bid is selected, applicants not chosen are notified that another bid was selected.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. It should be noted that different references to “an” or “one” embodiment in this disclosure are not necessarily to the same embodiment, and such references mean at least one. The present disclosure is illustrated by way of example, and not by way of limitation, in the figures of the accompanying drawings in which like references indicate similar elements, and wherein:

FIG. 1 illustrates an exemplary app in accordance with the present invention;

FIG. 2 is an exemplary flowchart in accordance with the present invention;

FIG. 3 is another view of the app of FIG. 1;

FIG. 4 is another view of the app of FIG. 1;

FIG. 5A is another view of the app of FIG. 1;

FIG. 5B is another view of the app of FIG. 1;

FIG. 6 is another view of the app of FIG. 1;

FIG. 7 is another view of the app of FIG. 1;

FIG. 8 is another view of the app of FIG. 1;

FIG. 9A is another view of the app of FIG. 1;

FIG. 9B is another view of the app of FIG. 1;

FIG. 10 is another view of the app of FIG. 1;

FIG. 11 is another view of the app of FIG. 1;

FIG. 12 is another view of the app of FIG. 1;

FIG. 13A is another view of the app of FIG. 1;

FIG. 13B is another view of the app of FIG. 1;

FIG. 14 is another view of the app of FIG. 1;

FIG. 15 is another view of the app of FIG. 1;

FIG. 16 is another view of the app of FIG. 1;

FIG. 17 is another view of the app of FIG. 1;

FIG. 18 is another view of the app of FIG. 1;

FIG. 19 is another view of the app of FIG. 1;

FIG. 20 is another view of the app of FIG. 1;

FIG. 21 is another view of the app of FIG. 1;

FIG. 22 is another view of the app of FIG. 1;

FIG. 23 is a flow diagram of an exemplary embodiment; and

FIGS. 24A and 24B are larger illustrations of the flow diagram of FIG. 23.

### DETAILED DESCRIPTION

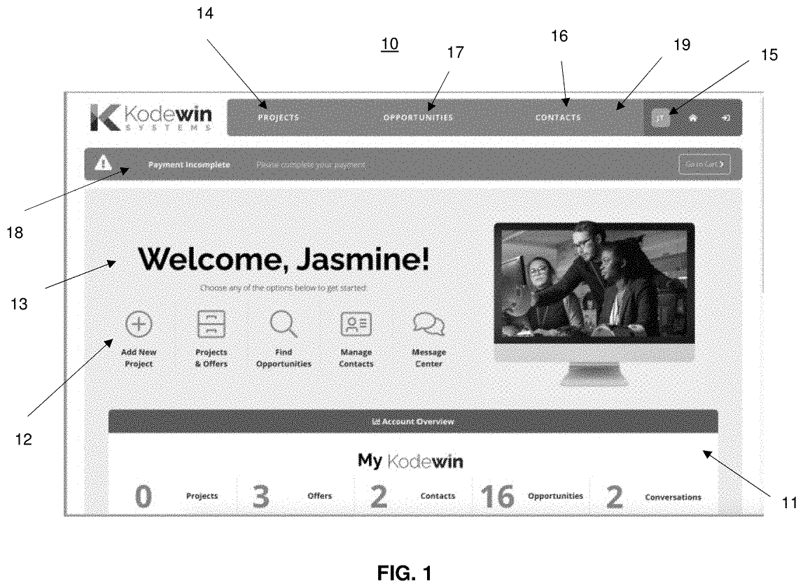

Directing attention to FIG. 1, an exemplary app in accordance with the present invention is illustrated. A preferred home screen interface 10 of the exemplary app may be accessed by a registered user 15 after the registered user 15 logs into the app. A registered user may include a buyer or a potential subcontractor/supplier. The home screen interface 10 includes a selection bar 19 having a “projects” link 14, an “opportunities” link 17, and a “contacts” link 16. The home screen interface 10 may provide a payment alert 18 to the registered user 15 when the registered user 15 has outstanding or incomplete payments. The home screen interface 10 of the exemplary app also provides a welcome page 13 having start options 12 where links to other interfaces of the app are provided, permitting the registered user 15 to navigate to add new projects, view existing projects and offers, search for bidders or bidding opportunities, manage contacts, or message other users. In addition, an account overview box 11 is provided for indicating the number of projects, offers, contacts, bidding opportunities, and conversations involving the registered user 15.

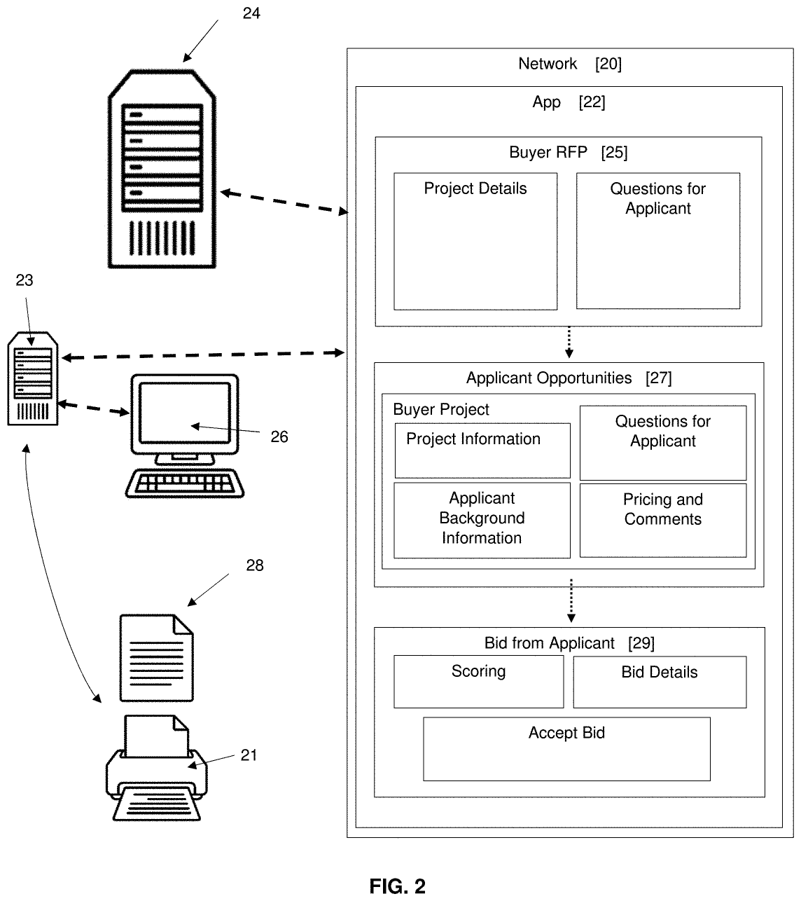

In an exemplary embodiment demonstrated by the exemplary flowchart of FIG. 2, a host data server 24 is in communication with a network 20 having an app 22, and the host data server 24 is configured to receive and store electronic information entered by a user 26 engaging app 22 through a user data server 23 having access to the network 20. The user 26 has the ability to download reports, documents, or other information from the app 22 to the user data server 23 where the reports, documents, or other information may be stored on the user data server 23 as an electronic file 28 and/or the user may print 21 the report, document, or other information. In addition, the user 26 has the ability to upload reports, documents or other information from the user data server 23 to the app 22.

The exemplary app 22 of the FIG. 2 embodiment includes features for the benefit of both buyer and applicant users 26. A preferred feature of the app 22 provides a buyer the ability to add buyer RFPs 25 where project details and questions for potential applicants may be entered or uploaded, and temporarily or permanently saved thereof to the host data server 24 for later use with respect to the same or another buyer RFP 25. Another preferred feature of the app 22 allows an applicant to access applicant opportunities 27, where the potential subcontractor may bid on available projects and/or the potential supplier may bid on opportunities to make a sale to the buyer (“sales opportunities”). The applicant opportunities 27 are saved to the app 22 through the host data server 24 as buyer RFPs 25. The applicant may select a buyer project or sales opportunity through the applicant opportunities feature 27, and thereafter the applicant would have access to project information and questions for the applicant created and saved by the buyer in the buyer RFP 25. The applicant opportunities feature 27 also includes the option for the applicant to type and/or upload and save and/or submit the applicant's answers to the questions for the applicant, applicant background information, and pricing and comments, which are temporarily or permanently saved thereof to the host data server 24 for later use with respect to the same or another applicant opportunity 27.

The exemplary app 22 of the FIG. 2 embodiment also includes a bid from applicant 29 feature, which permits the buyer to view scoring by the app 22 of an applicant's bid on the buyer's project or sales opportunity, and bid details. In addition, the bid from applicant 29 feature provides the buyer the option to accept the bid, or reject or ignore the bid. In certain preferred embodiments, the applicant receives an alert when the bid is accepted or rejected, and the buyer receives an alert when a bid is submitted and scored by the app, or withdrawn by the applicant. With preferred embodiments, an authorized user 26 may download information saved to the host data server 24 through the buyer RFP 25 feature, applicant opportunities 27 feature, or bid from applicant 29 feature to the user data server 23.

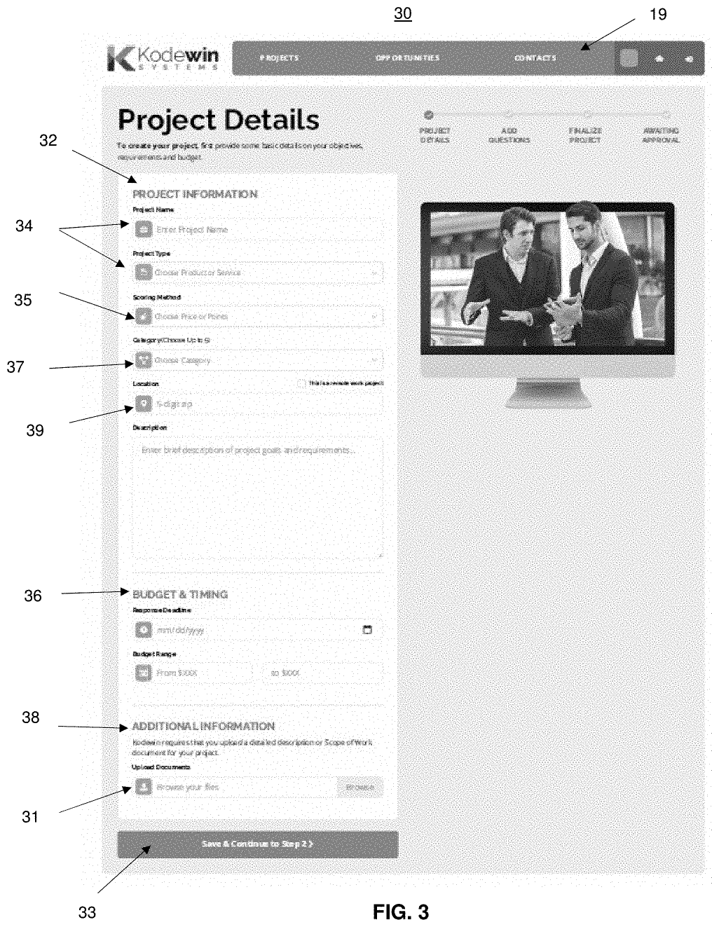

Referring now to FIG. 3, a project details interface 30 of the exemplary app of the FIG. 1 embodiment is illustrated. The project details interface 30 of FIG. 3 is accessed from the home screen interface 10 of FIG. 1 by selecting “add new project” from start options 12 of FIG. 1, which allows the buyer to begin a new RFP. Referring again specifically to FIG. 3, the project details interface 30 permits a buyer to add project information 32 for the buyer's RFP. The project information 32 includes an option to add basic RFP details 34 such as project name and type; an option for the buyer to configure an objective, numerical scoring method 35; an option to categorize 37 the RFP; and an option to add a project location and description 39. In addition, the project details interface 30 allows the buyer to add budget and timing information 36, and upload documents 31 providing additional information about the RFP. The buyer may save project information and continue with the RFP by selecting a link to save and continue 33. The project details interface 30 also includes the selection bar 19 of the FIG. 1 embodiment allowing the user to navigate to different features of the exemplary app.

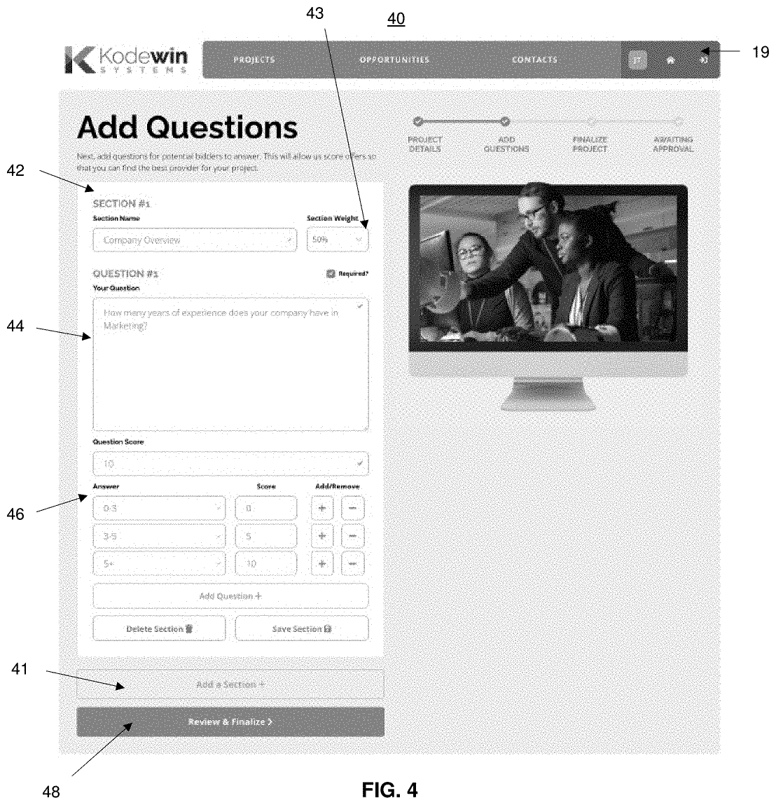

Referring to FIG. 4, an add questions interface 40 of the exemplary app of the FIG. 1 embodiment is illustrated. Referring to FIGS. 3-4, the add questions interface 40 may be accessed by selecting the link to save and continue 33 from the project details interface 30. Referring specifically to FIG. 4, the add questions interface 40 includes the option to select an “add a section” link 41, selection of which introduces a question section template 42. One or more category-specific questions 44 for applicants may be added to each question section template 44, and each question 44 may be provided scoring value 46 for objective evaluation of the applicant based the applicant's answers to one or more questions 44. In the preferred embodiment shown, scoring value 46 is set by the buyer assigning a numeric score to the answer based on at least one numeric value set out in that answer. The question section template 42 also includes the option for the buyer to categorize the questions 44 specific to that question section template 42 by providing a section name and weighting factor 43, where the weighting factor 43 is a multiplier for adjusting the scoring value 46 of the questions 44 specific to that question section template 42 with respect to the scoring value 46 for all questions factoring into the applicant's overall score. In one embodiment, and as illustrated in the figures, the section weighting factors add up to 100, so that they may be easily apportioned as a percentage and applied to the applicable scoring values within the section. The add questions interface 40 also includes the selection bar 19 of the FIG. 1 embodiment allowing the user to navigate to different features of the exemplary app. The buyer may save all question selection templates 42 and questions 44 therein, and continue with the RFP by selecting the “Review and Finalize” link 48. It should be understood that performing scoring evaluations using the exemplary app is not limited to the examples involving potential subcontractors or suppliers illustrated herein. The software may also be modified for other types of weighted scoring evaluations, such as in education for administering and evaluating tests, or in human resources for reviewing and evaluating job candidates, or in any other survey or inquiry benefiting from the use of objective criteria to score answers.

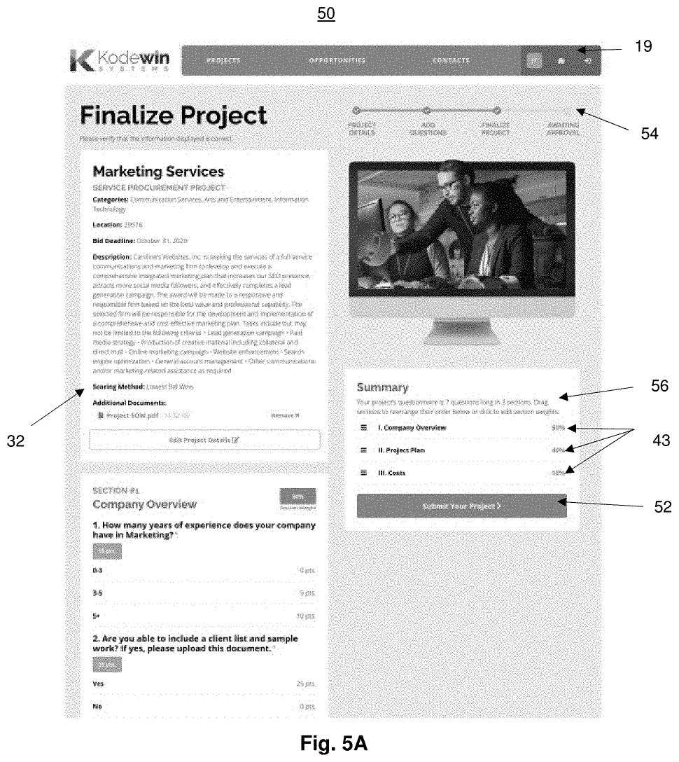

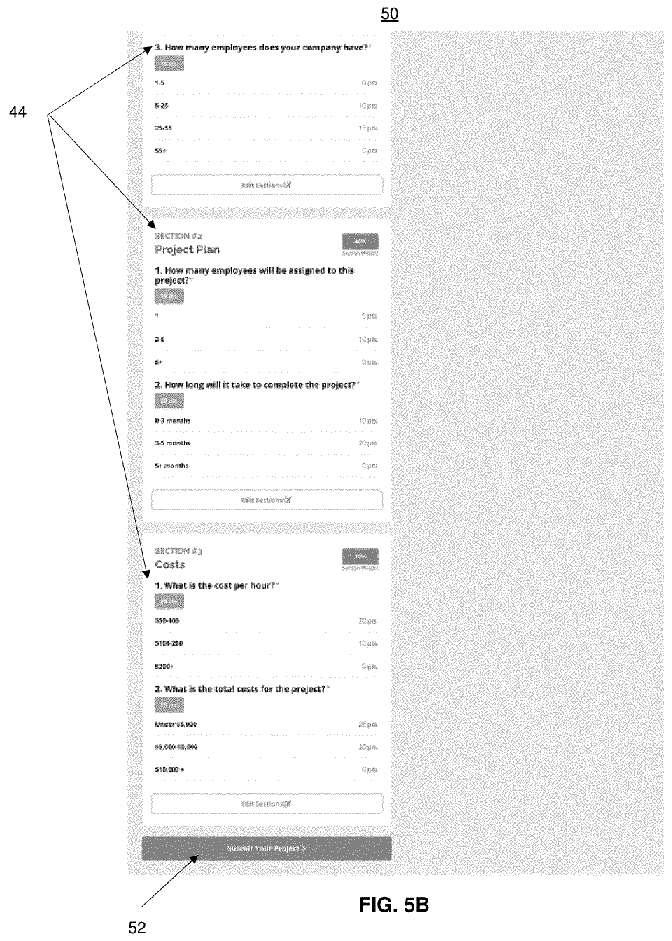

Thus, FIG. 4 illustrates creating a RFP based upon buyer input within a buyer interface including at least a buyer question interface to configure an objective scoring method. It illustrates the creation of “SECTION #1”, which is a first section, and creation of a plurality of first section questions, namely questions 1-3 as shown in FIGS. 5A and 5B, and a plurality of first section answers for each of the first section questions. For example, in FIG. 5A question 1 is “how many years experience does your company have in marketing?”, thus it is a first section first question, abbreviated FSFQ, and question 2 is “are you able to include a client list and sample work?”, thus it is a first section second question, abbreviated FSSQ. The illustrated question 1 has 3 potential answer, namely 0-3, which is a FSFQ first answer, 3-5, which is a FSFQ second answer, and 5+, which is a FSFQ third answer. Further, as seen in FIG. 4, in creating the RFP the buyer assigns a weighting factor 43 for each section, thus a first section weighting factor is illustrated. Similarly, the buyer assigns a score to each of the plurality of first section answers, also illustrated in FIG. 4 as a score of 0 for the “0-3” answer, and thus a FSFQ first answer score, a score of 5 for the “3-5” answer, and thus a FSFQ second answer score, and a score of 10 for the “5+” answer, and thus a FSFQ third answer score. This same disclosure applies equally to the other questions in the first section, as well as the method of creating additional sections such as “SECTION #2” illustrated in FIG. 5B, in other words a second section, and the associated plurality of second section questions and second section answers. For example, the plurality of second section questions includes at least a second section first question, abbreviated SSFQ, and a second section second question, abbreviated SSSQ. In this example, the SSFQ is “how many employees will be assigned to this project?”, while the SSSQ is “how long will it take to complete the project?” Similarly, the plurality of second section answers includes at least a SSFQ first answer, namely “1” in the example of FIG. 5B, a SSFQ second answer, namely “2-5” in the example, and a SSFQ third answer, namely “5+” in the example. Similarly, the buyer assigns a score to each of the plurality of second section answers, including a SSFQ first answer score, 5 points in the example, a SSFQ second answer score, 10 points in the example, a SSFQ third answer score, 0 points in the example, a SSSQ first answer score, 10 points in the example, a SSSQ second answer score, 20 points in the example, and a SSSQ third answer score, 0 points in the example. Like the first section, the second section is also assigned a second section weighting factor, and this method and disclosure applies equally to the third section illustrated in FIG. 5B.

Directing attention to FIG. 5A, a finalize project interface 50 may be accessed by the buyer selecting the “Review and Finalize” link 48 from the add questions interface 40. In preferred embodiments of the app, each RFP interface (collectively, the project details interface 30 of FIG. 3, the add questions interface 40 of FIG. 4, and the finalize project interface 50 of FIG. 5A) includes a toggling option 54 allowing the buyer to view its progress on the RFP and return or advance to different stages of the RFP before selecting the “Submit Your Project” link 52. After the buyer selects the “Submit Your Project” link 52, applicants will be able to view and bid on the buyer's project. The finalize project interface 50 allows the buyer to review and edit all project information 32 and view a question summary 56 having the names for question sections and weighting factors 43 thereof. The finalize project interface 50 also includes the selection bar 19 of the FIG. 1 embodiment allowing the user to navigate to different features of the exemplary app. Preferred embodiments of the present invention comprise the ability to temporarily or permanently save the buyer's questions 44, question section template 42 information, and scoring criteria (comprising scoring values 46 and weighting factors 43), and optionally link this information with future RFPs so that the buyer does not necessarily need to start each new RFP without having any questions 44, question section templates 42, or scoring criteria already prepared. This may allow a buyer to further save time and resources.

FIG. 5B is a screenshot of a lower portion of the finalize project interface 50 of the FIG. 5A embodiment. FIG. 5B illustrates the option for a buyer to review and edit all questions 44 included in the RFP on the finalize project interface 50 before submitting the RFP to bidders by selecting the “Submit Your Project” link 52. In preferred embodiments of the app, the buyer has the option to download all information available from the finalize project interface 50. Certain embodiments also permit applicants to receive alerts or notifications when an RFP relevant to that applicant's business is submitted.

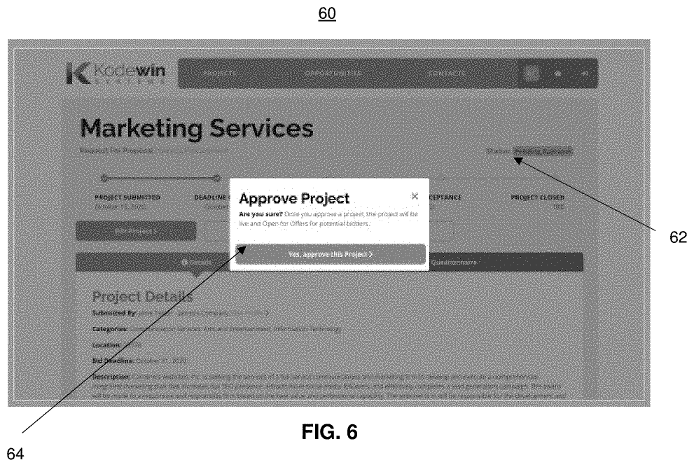

FIG. 6 illustrates a preferred final approval interface 60 where a final approval option link 64 must be selected by the buyer before the project becomes available on the app for bidding. An RFP status bar 62 will indicate that the RFP is “pending approval” until the final approval option link 64 is selected. Referring to FIGS. 5A-B and FIG. 6, the final approval interface 60 appears after the “Submit Your Project” link 52 is selected.

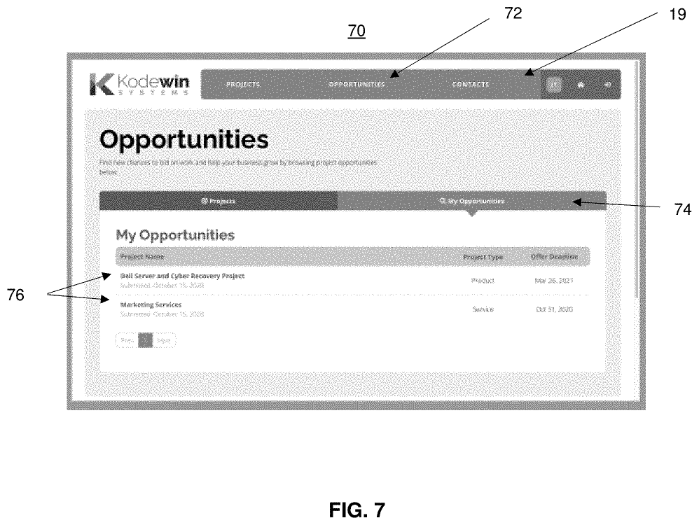

Referring now to FIG. 7, an applicant may access an opportunities interface 70, which permits the applicant to view potential projects or sales opportunities 76 available on the app for bidding, where the potential projects or sales opportunities 76 are saved or flagged by the applicant from a project search done using the app, and/or potential projects or sales opportunities 76 are identified by the app for the applicant based on the applicant's qualifications or some other specified criteria, also referred to as applicant-qualified RFPs. Generally speaking, the opportunities available may be set by an administrator (buyer or applicant) as a result of searches performed by the administrator using the app, based on industry codes added by the administrator, or based on one or more other opportunity-related categories set by the administrator. The opportunities interface 70 may be accessed by the applicant by selecting the opportunities link 72 from the selection bar 19 present in the various interfaces of the exemplary FIG. 1 app. The opportunities interface also includes a projects bar 74 where the applicant may navigate between potential projects or sales opportunities 76 and projects for which the applicant is a bidder or accepted bidder. The app continuously tracks project offers to configure potential projects or sales opportunities 76 for the administrator for the duration of the administrator's registration as a user of the app.

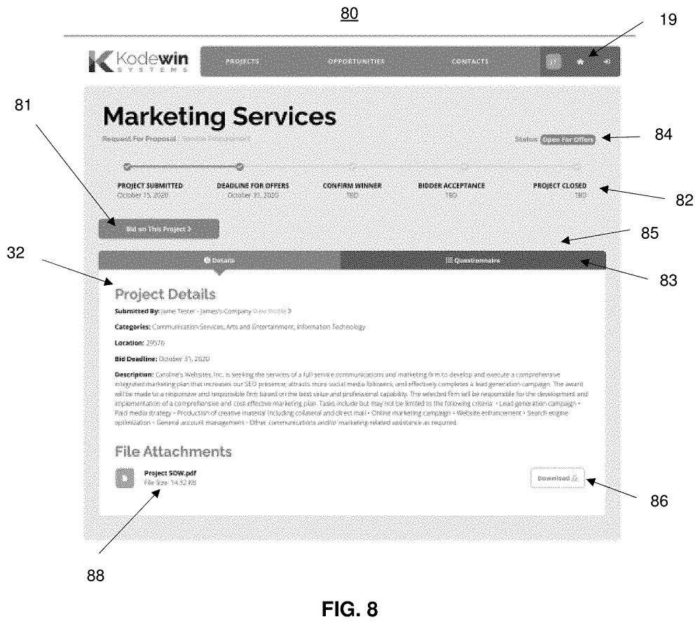

Referring to FIGS. 7-8 illustrating an exemplary bidding feature of the present invention, the applicant may select a potential project or sales opportunity 76 from the opportunities interface 70 to open a link to a first bidding interface 80. The first bidding interface 80 indicates the bid status 84 of the RFP, such as whether the project is open for offers from applicants. The first bidding interface 80 preferably includes a bidding progress bar 82 indicating the date the project was submitted, the deadline for submitting offers, whether a winning bid has been confirmed, whether there is officially an accepted bidder, and whether the project is still pending. The first bidding interface 80 also includes a bidding tab 85 where the applicant may navigate between project information 32 and an applicant questionnaire 83. The applicant may also download 86 file attachments 88 included with the project information 32. The applicant may initiate the bidding process by selecting a “Bid on This Project” link 81. The first bidding interface 80 also includes the selection bar 19 of the FIG. 1 embodiment allowing the user to navigate to different features of the exemplary app.

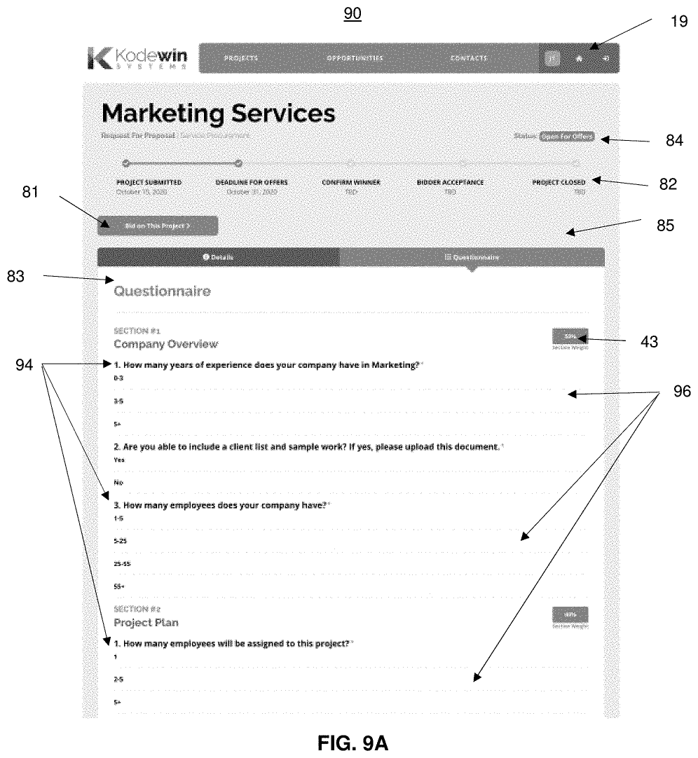

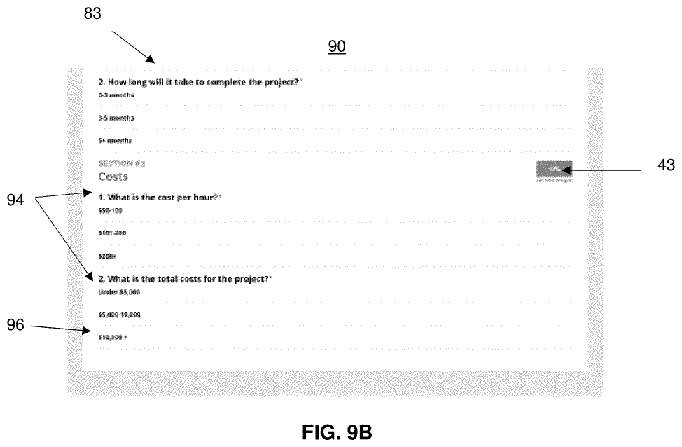

FIG. 9A illustrates a second bidding interface 90 of the FIG. 8 embodiment, where the applicant questionnaire 83 appears below the selection bar 19, bidding progress bar 82, bid status 84, “Bid on This Project” link 81, and bidding tab 85. The applicant questionnaire 83 includes questions 94 created by the buyer during the exemplary RFP process demonstrated by FIGS. 3-6. In certain embodiments, the weighting factor 43 will be visible to the applicant for each section of questions 94. In the embodiment shown, the questions 94 comprise numeric, multiple choice answers 96. However, in other embodiments, the applicant may type or upload answers to certain questions 94 as preferred or necessary, and those answers need not necessarily be numeric for scoring by the app. For example, an exemplary app may assign a score to an answer by identifying one or more words in that answer and associating a point value with the word(s) identified (an example yes or no question may include assigning ten points for a yes answer, or zero points for a no answer).

FIG. 9B is a screenshot of a lower portion of the questionnaire 83 of the second bidding interface 90. The questions 94 shown relate to costs to the buyer, and the multiple-choice answers 96 reflect various cost thresholds. The answer 96 scores may be adjusted based on the weighting factor 43. The applicant may select the “Bid on This Project” link 81 after the applicant has optionally reviewed the project information 32 and applicable file attachments 88, as well as the questionnaire 83, and determined that the applicant may be qualified to perform the work requested.

Thus, FIGS. 9A and 9B illustrate a process and method of a first applicant creating a first offer, as well as a second applicant creating a second offer, as well as any number of applicants and offers, including a second applicant and a second offer, a third applicant and a third offer, and on. Thus, the figures illustrate creating a first offer based upon first applicant input within an applicant interface including at least an applicant questionnaire bidding interface. Specifically, they illustrate the first applicant completing a first offer first section, abbreviated FOFS, by displaying each of the plurality of first section questions and the plurality of first section answers within the applicant questionnaire bidding interface. The first applicant designates a first offer FSFQ answer by selecting from the previously disclosed FSFQ first answer and the FSFQ second answer, as well as a first offer FSSQ answer by selecting from the FSSQ first answer and the FSSQ second answer. Similarly, the first applicant completes a first offer second section, abbreviated FOSS, by displaying each of the plurality of second section questions and the plurality of second section answers within the applicant questionnaire bidding interface. Further, the first applicant designates a first offer SSFQ answer by selecting from the previously disclosed SSFQ first answer and the SSFQ second answer, as well as a first offer SSSQ answer by selecting from the SSSQ first answer and the SSSQ second answer. A different applicant, namely a second applicant, may make an offer in response to the same RFP. Thus, the figures also illustrate creating a second offer based upon second applicant input within an applicant interface including at least an applicant questionnaire bidding interface. Specifically, they illustrate the second applicant completing a first offer first section, abbreviated FOFS, by displaying each of the plurality of first section questions and the plurality of first section answers within the applicant questionnaire bidding interface. The second applicant designates a first offer FSFQ answer by selecting from the previously disclosed FSFQ first answer and the FSFQ second answer, as well as a first offer FSSQ answer by selecting from the FSSQ first answer and the FSSQ second answer. Similarly, the second applicant completes a first offer second section, abbreviated FOSS, by displaying each of the plurality of second section questions and the plurality of second section answers within the applicant questionnaire bidding interface. Further, the second applicant designates a first offer SSFQ answer by selecting from the previously disclosed SSFQ first answer and the SSFQ second answer, as well as a first offer SSSQ answer by selecting from the SSSQ first answer and the SSSQ second answer. In the illustrated embodiment the first section weighting factor and the second section weighting factor are displayed to the first applicant and the second applicant within the applicant questionnaire bidding interface.

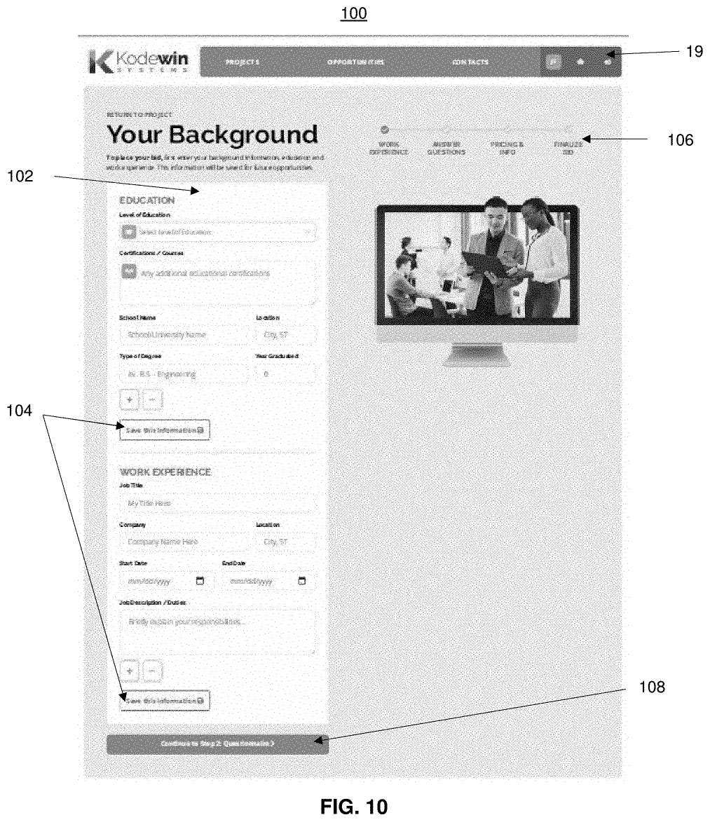

Referring now to FIG. 10, an applicant is directed to a background information bidding interface 100 after selecting the “Bid on This Project” link 81 from the second bidding interface 90. Directing attention specifically to FIG. 10, the background information bidding interface 100 includes a bidding toggle bar 106, which indicates to the applicant which step the applicant is on with respect to the bid submission process, and allows the applicant to navigate between different steps in the bid submission process. Below the selection bar 19, the background information bidding interface 100 includes a background information template 102 where the applicant may add information about the applicant's education and work experience. The background information may be saved 104 temporarily or permanently, and optionally linked to background information templates in other project bids, so that the applicant does not need to draft background information each time the applicant submits a new bid. Thus, a first offer by a first applicant may include a plurality of background information input by the first applicant in the background information bidding interface, which may then be utilized by the app to automatically display a plurality of applicant-qualified RFPs within an applicant opportunities interface based upon at least a portion of the plurality of background information, which as disclosed may include an industry specific code. Similarly, the app may to automatically display a plurality of applicant-qualified RFPs within an applicant opportunities interface based information other than the background information, namely information submitted by the first applicant in a previous offer. The applicant may progress to the questionnaire (not shown) by selecting the “Continue to Step 2: Questionnaire” link 108.

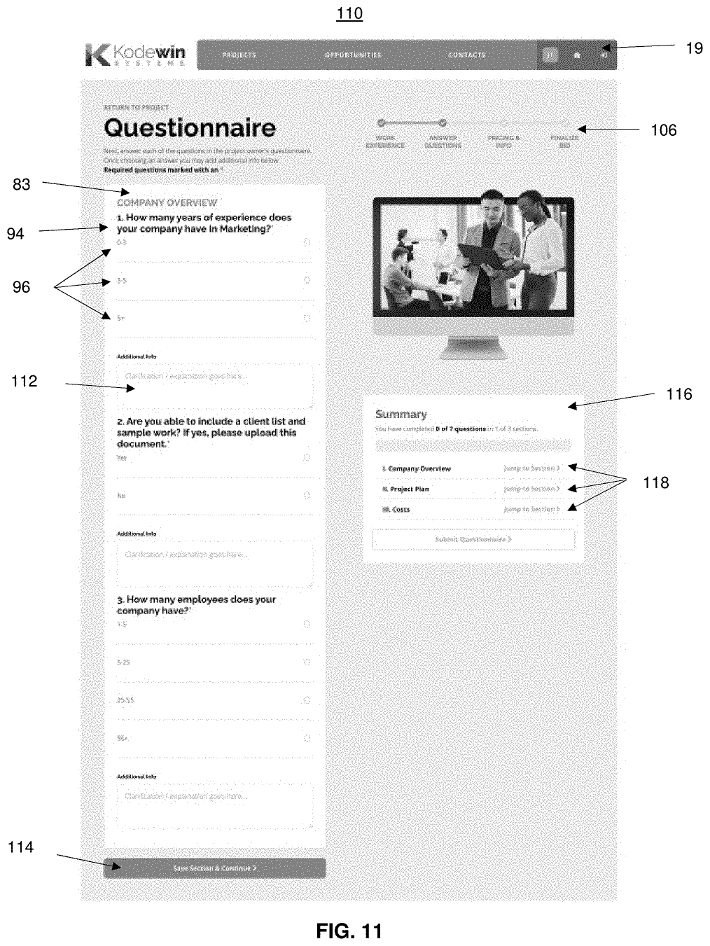

FIG. 11 illustrates a questionnaire bidding interface 110, where the questionnaire 83 is shown below the selection bar 19 and bidding toggle bar 106. In the embodiment shown, there is an option for the applicant to include additional information 112 with each answer 96 to questions 94. The applicant may save all answers and progress to a pricing estimate and additional information comment section (not shown) by selecting a “Save Section & Continue” link 114. Preferred embodiments of the present invention comprise the ability to temporarily or permanently save the applicant answers 96 and additional information 112, and optionally link those answers 96 and additional information 112 with identical or similar questions 94 in other project bids, so that the applicant does not need to draft the answers 96 and additional information 112 for questions 94 that have been answered before in previous project bids. The applicant may also identify which questions 94 from questionnaire 83 have been answered, and navigate to a specific section 118 of the questionnaire 83 by using the summary tool 116 of the questionnaire bidding interface 110.

Referring to FIG. 12, a fifth bidding interface 120 of the exemplary FIG. 1 app is illustrated. The fifth bidding interface 120 includes a pricing estimate and additional information comment section 122, which is shown below the selection bar 19 and bidding toggle bar 106. With respect to the pricing estimate and additional information comment section 122, the applicant may quote the price of its potential assistance with the buyer's project or its potential sale to the buyer, leave notes related to the quoted price, leave additional comments related to the bid for the buyer, and upload 124 any documents which may be relevant to the bid. The applicant may review the bid by selecting a continue and review bid link 126. All of the disclosure relating to the other sections, including scoring and weighting factors, applies equally to the pricing estimate and additional information comment section 122.

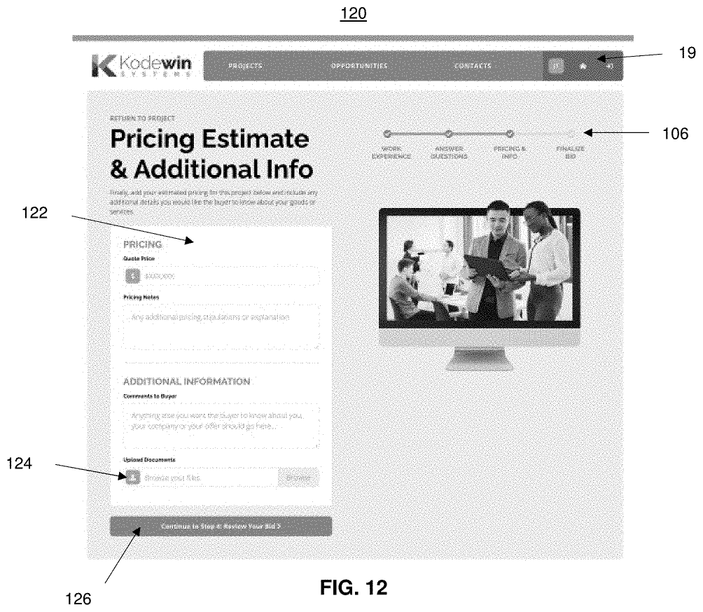

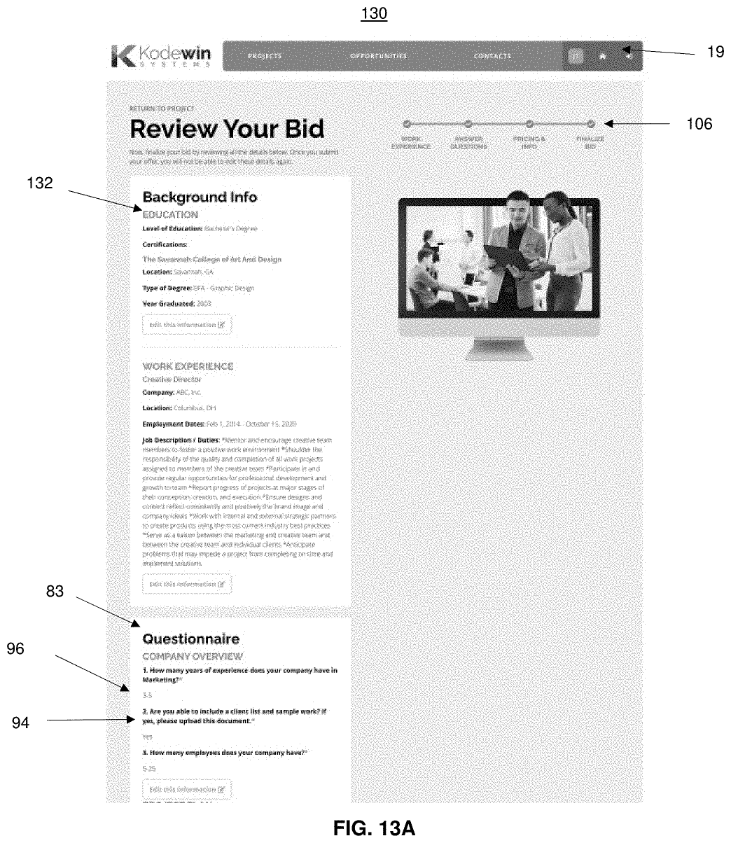

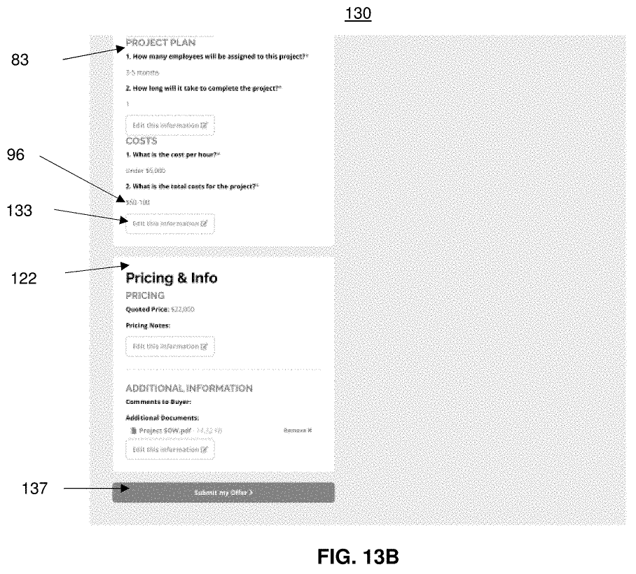

FIG. 13A illustrates a bid review interface 130 of the present app. After the applicant has completed each step of the bidding process, the bidding toggle bar 106 indicates that each step has been completed with check marks above each specific step. The applicant may use the bid review interface 130 to review and edit background information 132 and answers 96 to questions 94 of questionnaire 83. The bid review interface 130 also includes the selection bar 19 of the FIG. 1 embodiment allowing the user to navigate to different features of the exemplary app.

FIG. 13B is a screenshot of a lower portion of the bid review interface 130 of the FIG. 13A embodiment. The applicant may use the bid review interface 130 to review and edit 133 answers 96 from the questionnaire 83, including project or supply request plan and cost information, and the pricing estimate and additional information comment section 122. When the applicant has decided it is satisfied with the information included in the bid, the applicant may submit the bid by selecting the “Submit my Offer” link 137. Thus, the app may require an applicant secondary confirmation within an applicant bid review interface before the first offer or the second offer is available for creating the first offer weighted score or the second offer weighted score.

Directing attention to FIG. 14, the buyer may review all submitted bids by viewing an offer interface 140. Referring back to the FIG. 1 home screen interface 10, the buyer may access the offer interface 140 of FIG. 14 by selecting “Projects & Offers” from the start options 12. The home screen interface 10 may be accessed by selecting the home button on the selection bar 19. Referring specifically to FIG. 14, the offer interface 140 includes the bidding status 84 and bid progress bar 82, as well as a link for requesting a list of suppliers 143. In the exemplary embodiment shown, the top offer 146 is identified, where the top offer 146 is the bid assigned the highest numeric score 145 by the app. The buyer may view and/or download the information provided by the applicant for each bid by selecting the “View Offer” link 147. Total offers 141 are shown below the top offer 146, and the buyer may compare bidder price and numeric score 145 among all applicants by viewing total offers 141. Total offers 141 may be accessed from an offers tab 148 where the buyer may navigate between total offers 141, project or supply request details, and the questionnaire.

As previously disclosed with respect to FIG. 4, the weighting factor 43 is a multiplier for adjusting the scoring value 46 of the questions 44 specific to that question section template 42 with respect to the scoring value 46 for all questions factoring into the applicant's overall score. This process and method are further illustrated in FIG. 14. For example, in FIG. 14 “Jenny Tester” is the first applicant and “Jasmina Tester” is the second applicant. The web-based application (app) automatically generates the illustrated score. Specifically, the app creates a first offer weighted score, also referred to as the total score for the first applicant, automatically via a web-based application. The app creates a first offer FSFQ answer score based upon at least the selected FSFQ first answer and the FSFQ second answer, and the associated FSFQ first answer score and the FSFQ second answer score. Likewise the app creates a first offer FSSQ answer score based upon at least the selected FSSQ first answer and the FSSQ second answer, and the associated FSSQ first answer score and the FSSQ second answer score. Similarly the app creates a first offer SSFQ answer score based at least upon the selected SSFQ first answer and the SSFQ second answer, and the associated SSFQ first answer score and the SSFQ second answer score. Likewise the app creates a first offer SSSQ answer score based upon the selected SSSQ first answer and the SSSQ second answer, and the associated SSSQ first answer score and the SSSQ second answer score. One skilled in the art will appreciate that this method is easily extrapolated for any number of additional questions, and likewise sections and applicants. The app automatically scales a FOFS sum of the first offer FSFQ answer score and the first offer FSSQ answer score by the first section weighting factor to produce a scaled FOFS sum; and likewise scales a FOSS sum of the first offer SSFQ answer score and the first offer SSSQ answer score by the second section weighting factor to produce a scaled FOSS sum. The app then transforms the scaled FOFS sum and the scaled FOSS sum into the first offer weighted score, illustrated as 23 points for the first applicant, “Jenny Tester,” in FIG. 14.

Similarly, the app creates a second offer weighted score, also referred to as the total score for the second applicant, automatically via a web-based application. The app creates a second offer FSFQ answer score based upon at least the selected FSFQ first answer and the FSFQ second answer, and the associated FSFQ first answer score and the FSFQ second answer score. Likewise the app creates a second offer FSSQ answer score based upon at least the selected FSSQ first answer and the FSSQ second answer, and the associated FSSQ first answer score and the FSSQ second answer score. Similarly the app creates a second offer SSFQ answer score based at least upon the selected SSFQ first answer and the SSFQ second answer, and the associated SSFQ first answer score and the SSFQ second answer score. Likewise the app creates a second offer SSSQ answer score based upon the selected SSSQ first answer and the SSSQ second answer, and the associated SSSQ first answer score and the SSSQ second answer score. One skilled in the art will appreciate that this method is easily extrapolated for any number of additional questions, and likewise sections and applicants. The app automatically scales a SOFS sum of the second offer FSFQ answer score and the second offer FSSQ answer score by the first section weighting factor to produce a scaled SOFS sum; and likewise scales a SOSS sum of the second offer SSFQ answer score and the second offer SSSQ answer score by the second section weighting factor to produce a scaled SOSS sum. The app then transforms the scaled SOFS sum and the scaled SOSS sum into the second offer weighted score, illustrated as 35 points for the second applicant, “Jasmina Tester,” in FIG. 14. Thus, the app automatically displays the first offer weighted score and the second offer weighted score in the buyer offer interface, and automatically identifies a top offer, which may then be accepted by the buyer within a buyer confirmation interface, which may result in the app automatically alerting the first applicant or second applicant associated with the accepted offer.

This same methodology applies equally to the pricing estimate and additional information comment section 122 of FIG. 12. Specifically, the step of creating the RFP may further include creating a pricing estimate section, creating a pricing section question, assigning a pricing section score to the pricing section question, and assigning a pricing section weighting factor to the pricing section. Further, the step of creating the first offer may further include completing a first offer pricing section, abbreviated FOPS, by displaying the pricing section question within the applicant questionnaire bidding interface, and entering a FOPS answer by the first applicant, which is illustrated as the “quoted price” entry box of FIG. 12. Likewise, the step of creating the second offer may further include completing a second offer pricing section, abbreviated SOPS, by displaying the pricing section question within the applicant questionnaire bidding interface, and entering a SOPS answer by the second applicant. In such an embodiment the step of creating the first offer weighted score may further include creating a FOPS answer score based in part by comparing the FOPS answer and the SOPS answer, the app automatically scaling the FOPS answer score by the pricing section weighting factor to produce a scaled FOPS answer score, and the step of transforming the first offer weighted score then including the transformation of the scaled FOFS sum, the scaled FOSS sum, and the scaled FOPS answer score into the first offer weighted score. This applies equally to the step of creating the second offer weighted score. Thus, it may further include creating a SOPS answer score based in part by comparing the FOPS answer and the SOPS answer, automatically scaling the SOPS answer score by the pricing section weighting factor to produce a scaled SOPS answer score, with the step of transforming the second offer weighted score further including the transformation of the scaled SOFS sum, the scaled SOSS sum, and the scaled SOPS answer score into the second offer weighted score. The pricing estimate section may take the form of discrete multiple choice questions, which may include ranges of prices, such as section #3 questions 1 and 2 illustrated in FIG. 5B, or unrestricted entry fields such as illustrated as the “quoted price” entry box of FIG. 12, which may then likewise have a score assigned based upon buyer defined ranges, such as questions 1 and 2 in FIG. 5B, or by comparison of the quoted price with the quoted price of other offers, in other words by comparing the FOPS answer and the SOPS answer.

Similarly, this same methodology applies equally to the disclosure of FIG. 9A regarding assigning a score to an answer by identifying one or more words in that answer and associating a point value with the word(s) identified (an example yes or no question may include assigning ten points for a yes answer, or zero points for a no answer). Thus, the step of creating the plurality of first section questions may further include creating a first section unconstrained question, abbreviated FSUQ, and assigning a FSUQ answer score associated with at least one key word. Then, the step of creating the first offer further may include responding to the first section unconstrained question (FSUQ) with a FSUQ answer including at least one word. Further, the step of creating the first offer weighted score may further include identifying automatically via the web-based application if the FSUQ answer contains the at least one key word and assigning a FSUQ answer score based at least in part on whether the at least one key word is contained in the FSUQ answer, and scaling the FSUQ answer score by the first section weighting factor to produce a scaled FSUQ answer score. Additionally, the step of transforming the first offer weighted score may therefore further include transforming the scaled FOFS sum, the scaled FOSS sum, and the scaled FSUQ answer score into the first offer weighted score. One skilled in the art will appreciate that any of the sections may contain one or more such unconstrained questions, answers, scoring, and weighting methods and procedures.

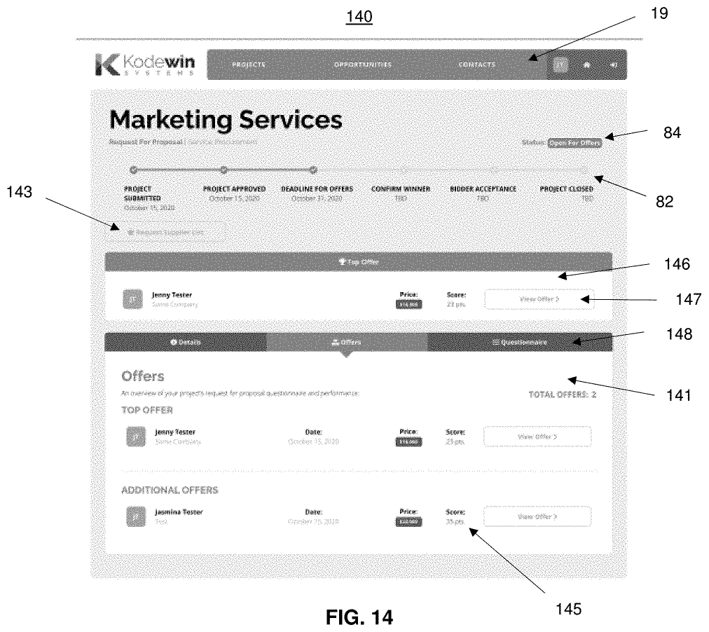

Referring now to FIG. 15, the buyer may accept 151, override 156, or reject 154 an offer with a specific score 145 using a confirmation interface 150, which is accessed by selecting the “View Offer” link 147 from the offer interface 140. In preferred embodiments of the present invention, the applicant will receive an alert when its bid is confirmed 151 or rejected 154. The confirmation interface 150 of the FIG. 15 embodiment includes a submission bar 152 where the buyer may view and/or download information about the applicant; offer details 153 where the buyer may view information about the price of the work, the applicant's background and credentials, and additional information; and a link to information from the questionnaire 83.

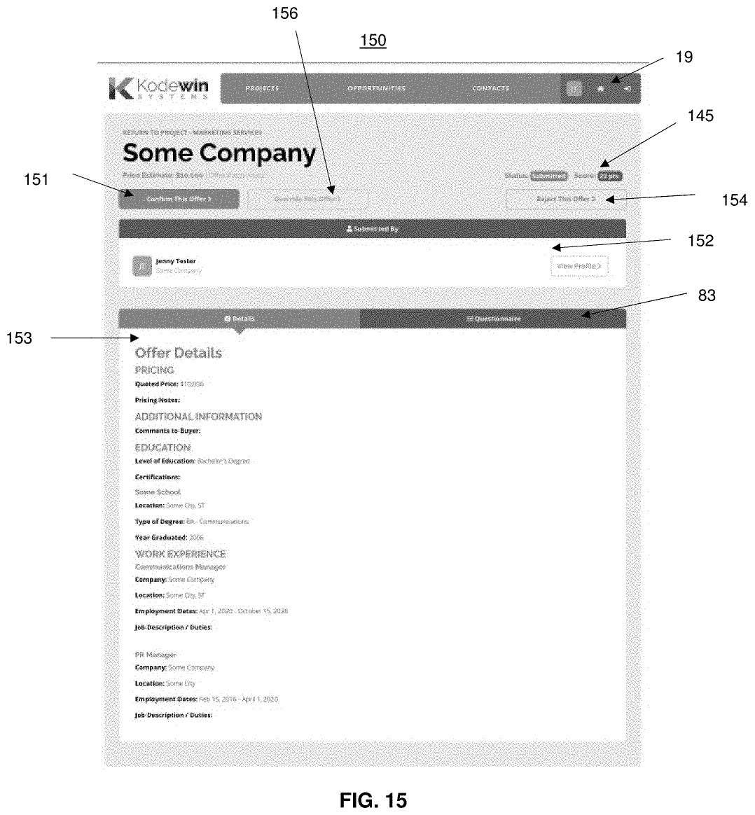

FIG. 16 illustrates a questionnaire review interface 160 of the FIGS. 14-15 embodiment. The questionnaire 83 and responses 162 thereof are shown below the selection bar 19, options to accept 151, override 156, or reject 154 the offer with the specific score 145. In preferred embodiments of the present invention, the buyer may download the responses 162.

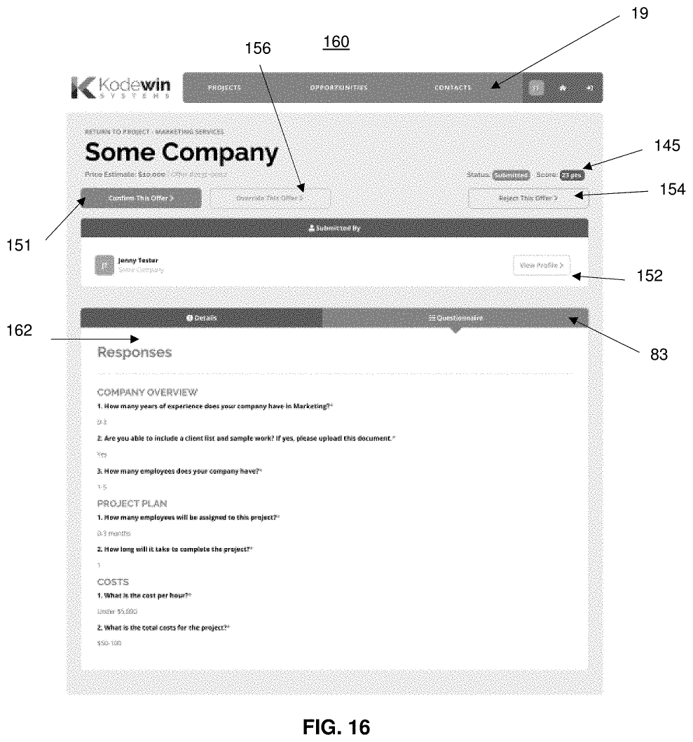

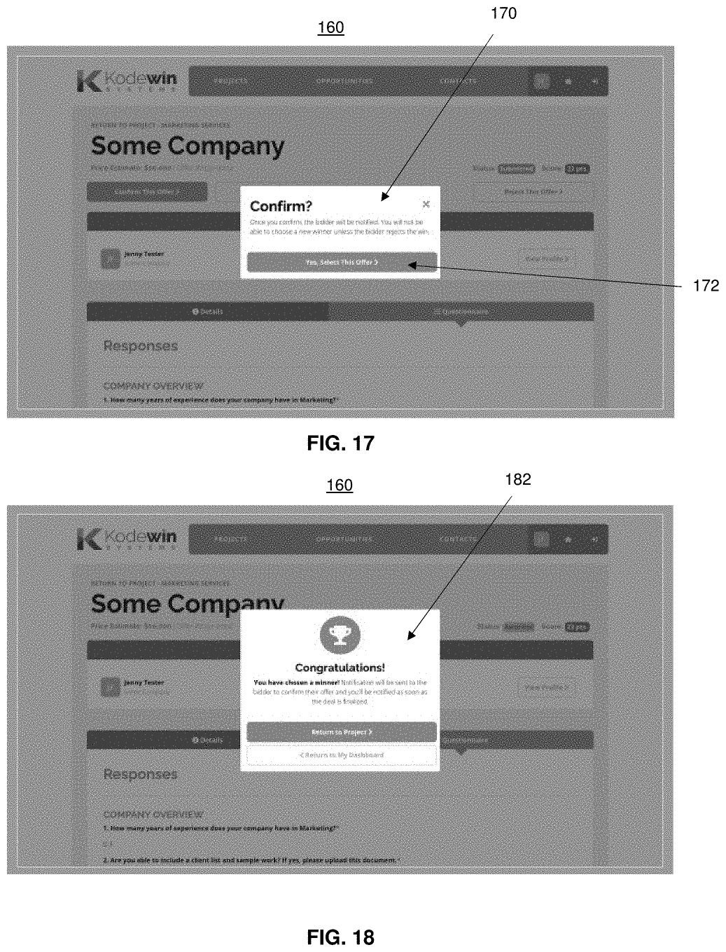

Referring to FIGS. 15-18, the buyer is asked to confirm 170 that a bid has been accepted after the buyer selects the accept 151 option from the questionnaire review interface 160 or confirmation interface 150. In the embodiment shown in FIG. 17, the buyer confirms 170 that a bid has been accepted by selecting the “Yes, Select This Offer” link 172. FIG. 18 illustrates a winner chosen message 182. Once the winner chosen message 182 appears on the questionnaire review interface 160 or confirmation interface 150, the accepted bidder will receive an alert that it has been awarded the project or sales opportunity. Thus, the method may require a buyer secondary confirmation within a buyer final approval interface before the first offer or the second offer is accepted within a buyer confirmation interface.

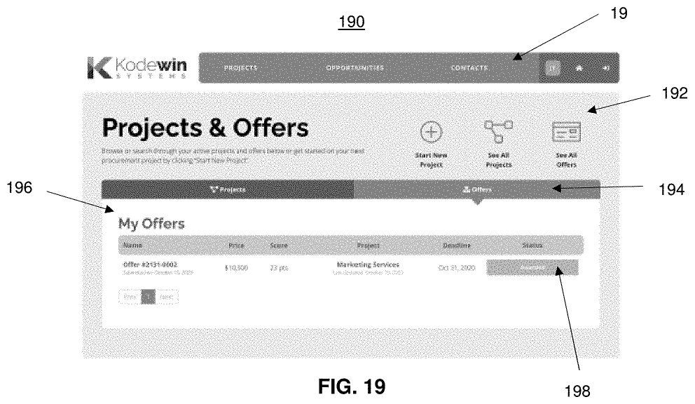

Directing attention now to FIG. 1 and FIG. 19, an applicant may view an offer status interface 190 by selecting “Projects & Offers” from the start options 12 of the home screen interface 10. The offer status interface 190 shows below the selection bar 19 an option to start a new project, see all other projects, or view all offers. An offer status tab 194 allows the applicant to navigate between an offers box 196 and viewing other projects. The offers listed in the offers box 196 include a status indicator 198 informing the applicant as to which bids, if any, have been accepted.

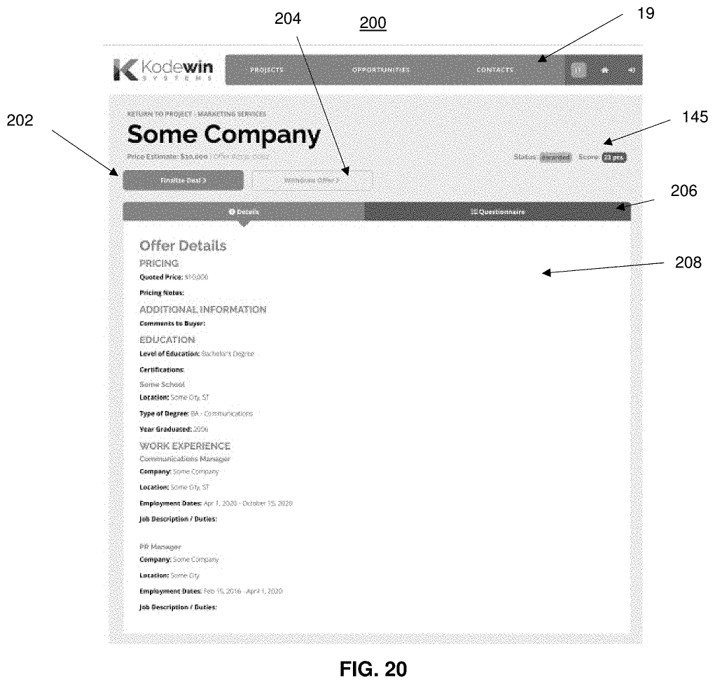

FIG. 20 illustrates a deal finalization interface 200, where, after an applicant has been awarded a project, the applicant may finalize the deal 202, withdraw the applicant's offer 204, view the applicant's score 145, and view and/or download the details 208 or questionnaire 206 related to the project. The deal finalization interface 200 also includes the selection bar 19 of the FIG. 1 embodiment allowing the user to navigate to different features of the exemplary app.

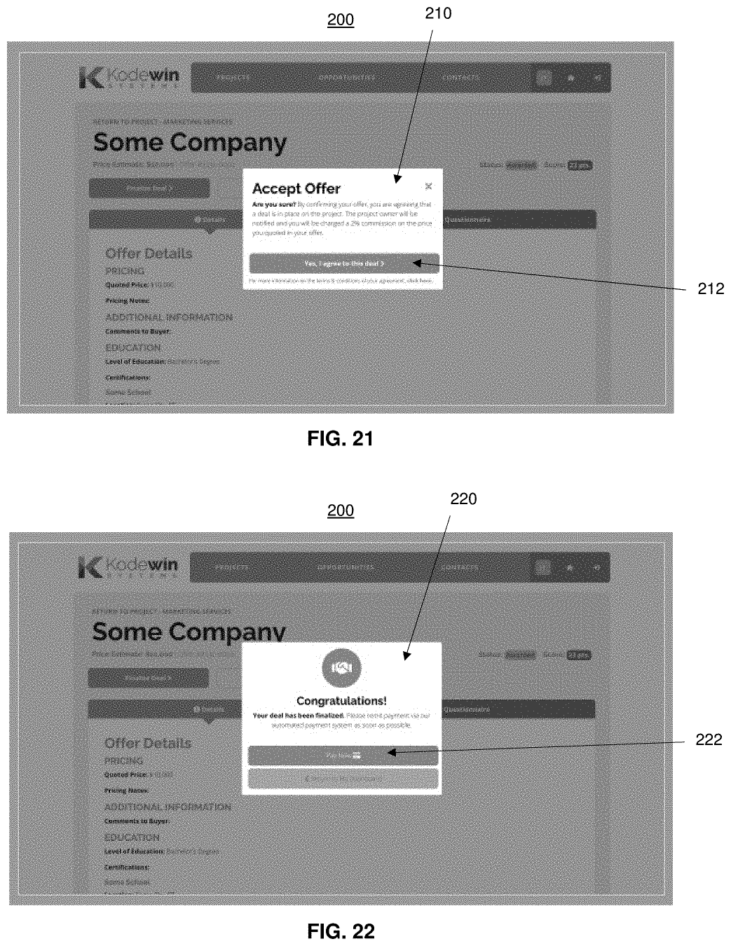

Referring now to FIGS. 20-22, when the finalize the deal 202 option is selected from the deal finalization interface 200, a confirmation check message 210 appears, and the applicant must select “Yes, I agree to this deal” 212 to confirm that the applicant is now a subcontractor or supplier for the buyer. After the applicant selects the “Yes, I agree to this deal” 212 option, a congratulatory message 220 will appear, the congratulatory message 220 including the option for the subcontractor or supplier to pay an app fee 222. Once the congratulatory message 220 appears on the deal finalization interface 200, the buyer will receive an alert that the deal has been finalized. Other applicants not selected by the buyer are notified that a different bid was selected.

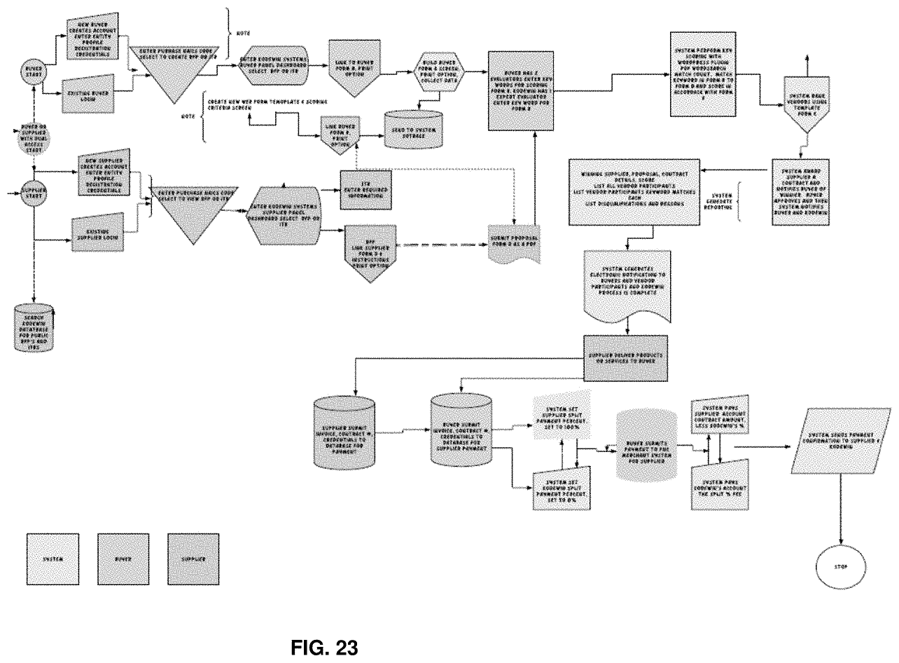

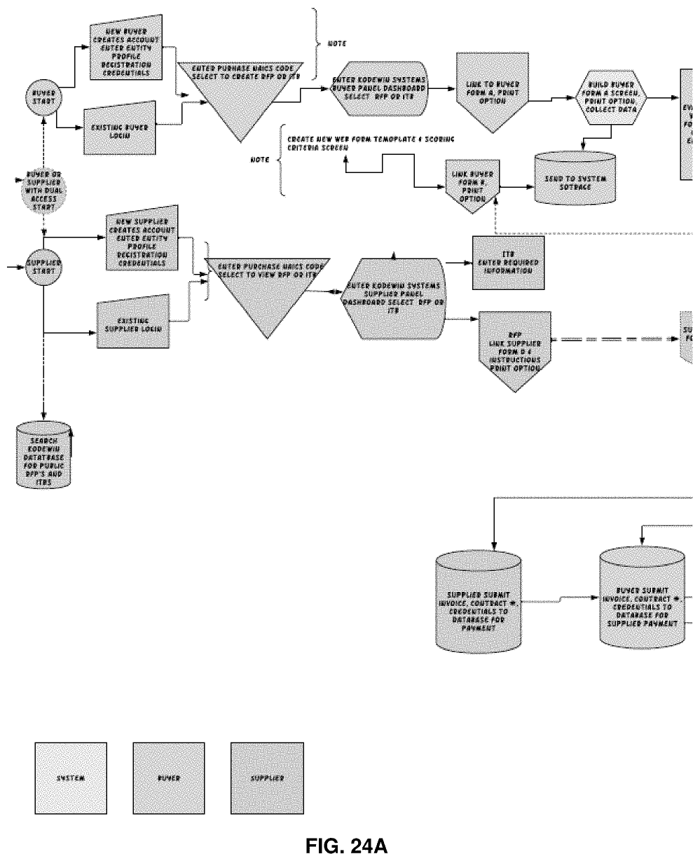

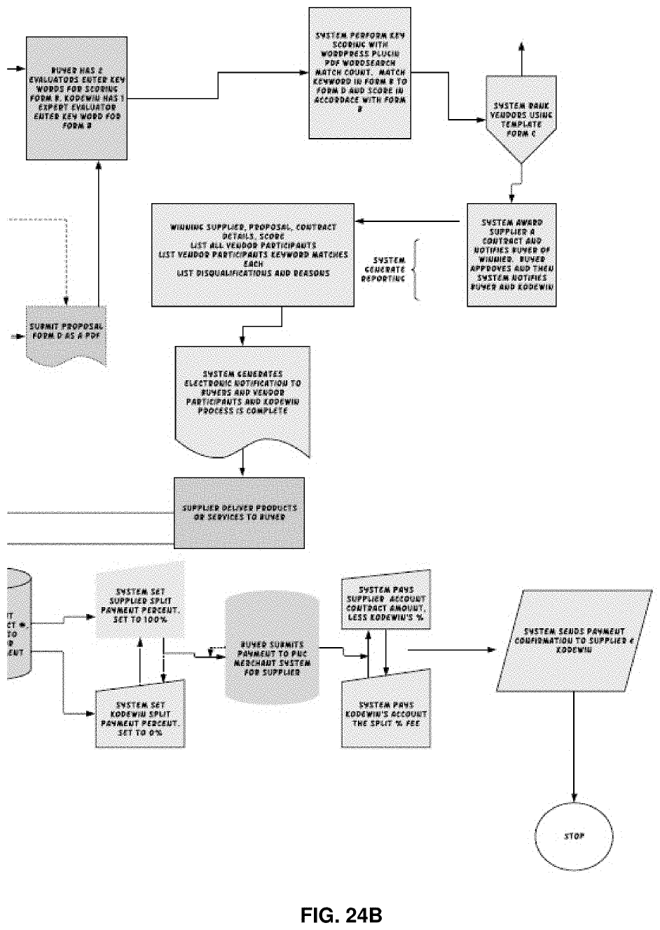

Referring to FIG. 23, a flow chart according to an exemplary embodiment is shown. While this flow chart depicts a method with certain steps utilizing a key word match model, in other exemplary embodiments a question and answer model may be used instead. Referring to FIGS. 24A and 24B, the flow chart of FIG. 23 is shown in larger format.

It is understood that the above descriptions and figures are intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A computer-implemented user-configurable web-based bidding and review method for connecting a buyer and a plurality of applicants including a first applicant and a second applicant, the method comprising:
a) creating a RFP based upon buyer input within a buyer interface including at least a buyer question interface to configure an objective scoring method, including:
creating a first section;
creating a plurality of first section questions and a plurality of first section answers for each of the first section questions;
wherein:
the plurality of first section questions includes at least a first section first question (FSFQ) and a first section second question (FSSQ); and
the plurality of first section answers includes at least a FSFQ first answer, a FSFQ second answer, a FSSQ first answer, and a FSSQ second answer;
assigning a first section weighting factor to the first section;
assigning a score to each of the plurality of first section answers, including a FSFQ first answer score, a FSFQ second answer score, a FSSQ first answer score, and a FSSQ second answer score;
creating a second section;
creating a plurality of second section questions and a plurality of second section answers for each of the second section questions;
wherein:
the plurality of second section questions includes at least a second section first question (SSFQ) and a second section second question (SSSQ); and
the plurality of second section answers includes at least a SSFQ first answer, a SSFQ second answer, a SSSQ first answer, and a SSSQ second answer;
assigning a second section weighting factor to the second section;
assigning a score to each of the plurality of second section answers, including a SSFQ first answer score, a SSFQ second answer score, a SSSQ first answer score, and a SSSQ second answer score;
b) creating a first offer based upon first applicant input within an applicant interface including at least an applicant questionnaire bidding interface, including:
completing a first offer first section (FOFS) by displaying each of the plurality of first section questions and the plurality of first section answers within the applicant questionnaire bidding interface, and:
designating a first offer FSFQ answer by selecting from the FSFQ first answer and the FSFQ second answer;
designating a first offer FSSQ answer by selecting from the FSSQ first answer and the FSSQ second answer;
completing a first offer second section (FOSS) by displaying each of the plurality of second section questions and the plurality of second section answers within the applicant questionnaire bidding interface, and:
designating a first offer SSFQ answer by selecting from the SSFQ first answer and the SSFQ second answer;
designating a first offer SSSQ answer by selecting from the SSSQ first answer and the SSSQ second answer;
creating a second offer based upon second applicant input within the applicant questionnaire bidding interface, including:
completing a second offer first section (SOFS) by displaying each of the plurality of first section questions and the plurality of first section answers within the applicant questionnaire bidding interface, and:
designating a second offer FSFQ answer by selecting from the FSFQ first answer and the FSFQ second answer;
designating a second offer FSSQ answer by selecting from the FSSQ first answer and the FSSQ second answer;
completing a second offer second section (SOSS) by displaying each of the plurality of second section questions and the plurality of second section answers within the applicant questionnaire bidding interface, and:
designating a second offer SSFQ answer by selecting from the SSFQ first answer and the SSFQ second answer;
designating a second offer SSSQ answer by selecting from the SSSQ first answer and the SSSQ second answer;
c) creating a first offer weighted score automatically via a web-based application, including:
creating a first offer FSFQ answer score based upon the selected FSFQ first answer and the FSFQ second answer, and the associated FSFQ first answer score and the FSFQ second answer score;
creating a first offer FSSQ answer score based upon the selected FSSQ first answer and the FSSQ second answer, and the associated FSSQ first answer score and the FSSQ second answer score;
creating a first offer SSFQ answer score based upon the selected SSFQ first answer and the SSFQ second answer, and the associated SSFQ first answer score and the SSFQ second answer score;
creating a first offer SSSQ answer score based upon the selected SSSQ first answer and the SSSQ second answer, and the associated SSSQ first answer score and the SSSQ second answer score;
scaling a FOFS sum of the first offer FSFQ answer score and the first offer FSSQ answer score by the first section weighting factor to produce a scaled FOFS sum;
scaling a FOSS sum of the first offer SSFQ answer score and the first offer SSSQ answer score by the second section weighting factor to produce a scaled FOSS sum;
transforming the scaled FOFS sum and the scaled FOSS sum into the first offer weighted score;
d) creating a second offer weighted score automatically via the web-based application automatically, including:
creating a second offer FSFQ answer score based upon the selected FSFQ first answer and the FSFQ second answer, and the associated FSFQ first answer score and the FSFQ second answer score;
creating a second offer FSSQ answer score based upon the selected FSSQ first answer and the FSSQ second answer, and the associated FSSQ first answer score and the FSSQ second answer score;
creating a second offer SSFQ answer score based upon the selected SSFQ first answer and the SSFQ second answer, and the associated SSFQ first answer score and the SSFQ second answer score;
creating a second offer SSSQ answer score based upon the selected SSSQ first answer and the SSSQ second answer, and the associated SSSQ first answer score and the SSSQ second answer score;
scaling a SOFS sum of the second offer FSFQ answer score and the second offer FSSQ answer score by the first section weighting factor to produce a scaled SOFS sum;
scaling a SOSS sum of the second offer SSFQ answer score and the second offer SSSQ answer score by the second section weighting factor to produce a scaled SOSS sum;
transforming the scaled SOFS sum and the scaled SOSS sum into the second offer weighted score;
e) displaying the first offer weighted score and the second offer weighted score in a buyer offer interface, and automatically identifying a top offer;
f) accepting the first offer or the second offer within a buyer confirmation interface, via buyer input; and
g) alerting the first applicant or second applicant associated with the accepted offer, automatically via the web-based application;
h) wherein the web-based application is in communication with one or more host data servers, one or more user data servers, and a communication network.

2. The method of claim 1, further including the step of alerting the first applicant or second applicant associated with a non-accepted offer, automatically via the web-based application.

3. The method of claim 2, further including the step of directing the first applicant or second applicant associated with the accepted offer, automatically via the web-based application, to an applicant deal finalization interface whereby the accepted offer must be finalized or withdrawn.

4. The method of claim 1, further including the step of displaying the first section weighting factor and the second section weighting factor to the first applicant and the second applicant within the applicant questionnaire bidding interface.

5. The method of claim 1, further including the step of the first applicant searching from a plurality open RFPs within an applicant opportunities interface of the applicant interface.

6. The method of claim 1, wherein the step of creating the first offer further includes the first applicant completing a plurality of background information within a background information bidding interface, and further including the step of displaying a plurality of applicant-qualified RFPs within an applicant opportunities interface of the applicant interface, automatically via the web-based application based upon at least a portion of the plurality of background information.

7. The method of claim 6, further including the step of the first applicant selecting one of the plurality of applicant-qualified RFPs and creating an auxiliary offer, whereby at least a portion of the plurality of background information from the first offer is automatically populated within the background information bidding interface of the auxiliary offer.

8. The method of claim 6, wherein the plurality of background information includes at least one industry code, and the plurality of applicant-qualified RFPs automatically displayed within the applicant opportunities interface are based upon the at least one industry code.

9. The method of claim 1, further including the step of the displaying a plurality of applicant-qualified RFPs within an applicant opportunities interface of the applicant interface, automatically via the web-based application based upon information contained in the first offer.

10. The method of claim 1, further including the step of the displaying all offers submitted by the first applicant within an applicant offer status interface of the applicant interface and a status indicator for each offer.

11. The method of claim 1, further including the step of the displaying a bidding toggle bar within an applicant bid review interface whereby a visual indicator displays to the first applicant the steps completed in submitting the first offer.

12. The method of claim 1, further including the step of the displaying a total quantity of questions associated with the RFP and a quantity of completed questions within the applicant questionnaire bidding interface.

13. The method of claim 1, further including the step requiring a buyer secondary confirmation within a buyer final approval interface before the first offer or the second offer is accepted within a buyer confirmation interface.

14. The method of claim 1, further including the step requiring an applicant secondary confirmation within an applicant bid review interface before the first offer or the second offer is available for creating the first offer weighted score or the second offer weighted score by the web-based application.

15. The method of claim 1, further including the step of the displaying a bidding progress bar within the applicant interface whereby a visual indicator displays to the first applicant a status of the first offer including at least one of a project submitted indication, a deadline for offers indication, and a project closed indication.

16. The method of claim 1, wherein the step of creating the plurality of first section questions and the plurality of first section answers further includes the step of accessing a question section template containing a plurality of template questions and a plurality of template answers, and selecting from the plurality of template questions and the plurality of template answers to create the a portion of the plurality of first section questions and a portion of the plurality of first section answers.

17. The method of claim 1, further including the step of the displaying on a buyer finalize project interface all of the plurality of first section questions, the plurality of first section answers, the first section weighting factor, the second section weighting factor, the FSFQ first answer score, the FSFQ second answer score, the FSSQ first answer score, the FSSQ second answer score, the SSFQ first answer score, the SSFQ second answer score, the SSSQ first answer score, and the SSSQ second answer score, and permitting editing of any of the first section weighting factor, the second section weighting factor, the FSFQ first answer score, the FSFQ second answer score, the FSSQ first answer score, the FSSQ second answer score, the SSFQ first answer score, the SSFQ second answer score, the SSSQ first answer score, and the SSSQ second answer score, directly from the buyer finalize project interface.

18. The method of claim 1, wherein:
the step of creating the RFP further includes:
creating a pricing estimate section;
creating a pricing section question;
assigning a pricing section score to the pricing section question;
assigning a pricing section weighting factor to the pricing section;
the step of creating the first offer further includes completing a first offer pricing section (FOPS) by displaying the pricing section question within the applicant questionnaire bidding interface, and entering a FOPS answer by the first applicant;
the step of creating the second offer further includes completing a second offer pricing section (SOPS) by displaying the pricing section question within the applicant questionnaire bidding interface, and entering a SOPS answer by the second applicant;
the step of creating the first offer weighted score further includes:
creating a FOPS answer score based in part by comparing the FOPS answer and the SOPS answer;
scaling the FOPS answer score by the pricing section weighting factor to produce a scaled FOPS answer score; and
wherein the step of transforming the first offer weighted score further includes transforming the scaled FOFS sum, the scaled FOSS sum, and the scaled FOPS answer score into the first offer weighted score;
the step of creating the second offer weighted score further includes:
creating a SOPS answer score based in part by comparing the FOPS answer and the SOPS answer;
scaling the SOPS answer score by the pricing section weighting factor to produce a scaled SOPS answer score; and
wherein the step of transforming the second offer weighted score further includes transforming the scaled SOFS sum, the scaled SOSS sum, and the scaled SOPS answer score into the second offer weighted score.

19. The method of claim 1, wherein:
the step of creating the plurality of first section questions further includes:
creating a first section unconstrained question (FSUQ);
assigning a FSUQ answer score associated with at least one key word;
the step of creating the first offer further includes:
responding to the first section unconstrained question (FSUQ) with a FSUQ answer including at least one word;
the step of creating the first offer weighted score further includes:
identifying automatically via the web-based application if the FSUQ answer contains the at least one key word and assigning a FSUQ answer score based at least in part on whether the at least one key word is contained in the FSUQ answer;
scaling the FSUQ answer score by the first section weighting factor to produce a scaled FSUQ answer score; and
wherein the step of transforming the first offer weighted score further includes transforming the scaled FOFS sum, the scaled FOSS sum, and the scaled FSUQ answer score into the first offer weighted score.
